(19) United States
(12) Patent Application Publication
(10) Pub. No.: US 2012/0230405 A1
(43) Pub. Date: Sep. 13, 2012

(54) VIDEO CODING METHODS AND VIDEO ENCODERS AND DECODERS WITH LOCALIZED WEIGHTED PREDICTION

(75) Inventors: Jicheng An, Beijing City (CN); Xun Guo, Beijing (CN); Yu-Wen Huang, Taiwan (TW); Shaw-Min Lei, Taipei City (TW)

(73) Assignee: MEDIA TEK SINGAPORE PTE. LTD., Ayer Rajah rescent (SG)

(21) Appl. No.: 12/995,292

(22) PCT Filed: Aug. 6, 2010
(86) PCT No.: PCT/CN10/75763

§ 371 Date: Nov. 30, 2010

Related U.S. Application Data
(60) Provisional application No. 61/255,516, filed on Oct. 28, 2009.

(51) Int. Cl. H04N 7/32

(52) U.S. Cl. 375/240.13; 375/E07.243

(57) ABSTRACT

Methods, encoders, and decoders with localized weighted prediction are disclosed. A decoding method includes decoding data for a current segment to generate decoded data including residuals and a weighted prediction parameter for the current segment. A weighted prediction for the current segment is generated based on the weighted prediction parameter. A predictor for the current segment is generated by intra/inter prediction. The weighted prediction and the predictor are combined to obtain a modified predictor, and the current segment is reconstructed according to the modified predictor and the residuals.

### BACKGROUND OF THE INVENTION

1. Field of the Invention

The disclosure relates generally to video coding, and more particularly, to video coding methods and coding devices with localized weighted prediction.

2. Description of the Related Art

H.264/AVC (Advanced Video Coding) is a video compression standard, which contains a number of techniques allowing efficient coding rate and flexibility for a wide range of applications. Weighted prediction (WP) is a tool in the current H.264 standard. In the H.264 WP tool, a multiplicative weighting factor (hereinafter referred to as scaling factor) and an additive offset are applied to the motion compensated prediction. WP includes two modes, implicit WP supported in B slices, and explicit WP supported in P, SP, and B slices. In explicit mode, a single scaling factor and offset are coded in the slice header for each allowable reference picture index. In implicit mode, the scaling factors and offsets are not coded in the slice headers but are derived based on relative picture order count (POC) distances of the current picture and its reference pictures. The original usage of WP is to compensate global luminance and chrominance differences between the current picture and temporal reference pictures. The WP tool is particularly effective for coding fading sequences.

### BRIEF SUMMARY OF THE INVENTION

An embodiment of a method for video decoding includes the steps of: acquiring data for a current segment to be decoded from an input bitstream; decoding the acquired data to generate decoded data including residuals and a weighted prediction parameter for the current segment; generating a weighted prediction for the current segment based on the weighted prediction parameter; generating a predictor for the current segment by intra/inter prediction; combining the weighted prediction and the predictor to obtain a modified predictor; and reconstructing the current segment according to the modified predictor and the residuals.

In one embodiment, a video decoder is provided, which comprises a decoding unit, a determination unit and a motion compensation unit. The decoding unit acquires data for a current segment to be decoded from an input bitstream and decodes the acquired data to generate decoded data comprising residuals and a weighted prediction parameter for the current segment. The determination unit is coupled to the decoding unit for generating a weighted prediction for the current segment based on the weighted prediction parameter. The motion compensation unit generates a predictor for the current segment by intra/inters prediction. The video decoder further combines the weighted prediction and the predictor to obtain a modified predictor and reconstructs the current segment according to the modified predictor and the residuals.

Another embodiment of a method for video encoding includes the steps of: acquiring a current segment of a slice to be encoded; generating a predictor of the current segment by intra/inter prediction; performing weighted prediction on the predictor of the current segment to generate a modified predictor and a weighted prediction parameter; generating residuals according to the current segment and the modified predictor; and encoding the residuals and inserting the weighted prediction parameter to generate a bitstream.

In another embodiment, a video encoder is provided, which comprises an intra/inter prediction unit, a determination unit, a transform and quantization unit and an entropy coding unit. The intra/inter prediction unit generates a predictor of a current segment by intra/inter prediction. The determination unit is coupled to the intra/inter prediction unit for performing weighted prediction on the predictor of the current segment to generate a modified predictor and a weighted prediction parameter. The transform and quantization unit further receives residuals and performs transform and quantization on the residuals to generate quantized values, wherein the residuals are generated according to the current segment and the modified predictor. The entropy coding unit further encodes the quantized values and inserts the weighted prediction parameter to generate a bitstream.

Video encoding/decoding methods, encoders and decoders may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a block diagram illustrating a video encoder according to an embodiment of the present invention;

FIG. 2 is a block diagram illustrating a video decoder according to an embodiment of the present invention;

FIG. 3 illustrates an embodiment of deriving an offset predictor for an MB;

FIG. 4 is a flowchart of an embodiment of a video decoding method of the invention;

FIG. 5 illustrates an embodiment of a video frame; and

FIG. 6 illustrates an embodiment of a frame structure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the following description, for explanatory convenience, an exemplary H.26x video sequence will be utilized, but the invention is not limited thereto. The H.26x video sequence may comprise multiple pictures or groups of pictures (GOPs) that can be arranged in a specific order referred to as the GOP structure. Each picture may further be divided into one or multiple slices. Each slice may be divided into multiple segments where the segments may be blocks of any shape with a size smaller than that of the slice, for example, the segment may be 128×128, 64×64, 32×16, 16×16, 8×8, or 4×8 pixels. Localized weighted prediction allows better prediction when illumination variations between pictures are unevenly distributed in a picture. For explanatory convenience, the following descriptions assume that a slice is divided into multiple macroblocks (MBs), and weighted prediction operations are performed in the unit of a MB, but the invention is not limited to MB level, localized weighted prediction can be applied to segments with a size smaller than a slice.

A video encoder performs inter prediction or intra prediction on each MB of a received picture to derive a predictor for each MB. For example, a similar MB in a reference picture is found for use as a predictor for a current MB when performing inter prediction. A motion vector difference and reference picture index for the current MB will be encoded into a bitstream to indicate the location of the predictor in the reference picture. In other words, the reference picture index indicates which previously decoded picture is used as the reference picture and a motion vector derived from the motion vector difference indicates the displacement between the spatial location of the current MB and the spatial location of the predictor in the reference frame. Besides directly obtaining the predictor from the previously decoded picture, the predictor can be obtained by interpolation in the case of sub-pixel precision motion vectors.

WP then applies to the predictor of the current MB, either derived from inter prediction or intra prediction, to generate a modified predictor by multiplying a scaling factor, adding a prediction offset, or both on the original predictor.

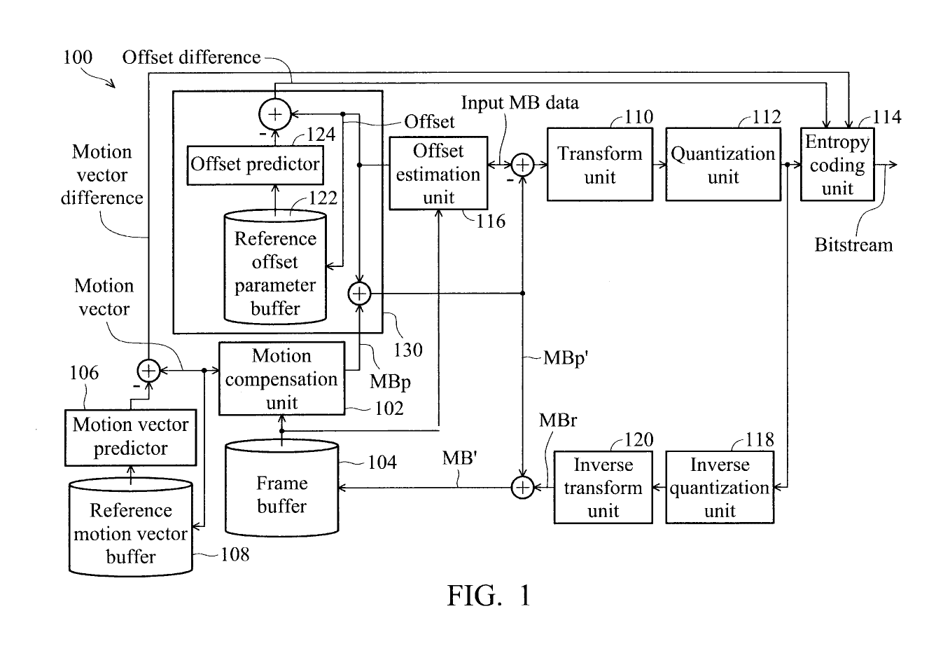

FIG. 1 is a block diagram illustrating a video encoder 100 with localized weighted prediction according to an embodiment of the present invention. In this embodiment, the video encoder 100 encodes input video data MB by MB. FIG. 1 only demonstrates localized weighted prediction applied in inter prediction, however, it should not be a limit to the invention as localized weighted prediction can also be applied to intra prediction. In FIG. 1, a modified predictor is calculated based on a prediction offset, it is only an example of weighted prediction, in some other embodiments, a scaling factor, or a prediction offset together with a scaling factor, are used to calculate the modified predictor. The video encoder 100 comprises a motion compensation unit 102, a frame buffer 104, a reference motion vector buffer 108, a transform unit 110, a quantization unit 112, an entropy coding unit 114, an offset estimation unit 116, an inverse quantization unit 118, an inverse transform unit 120 and a reference offset parameter buffer 122. The reference motion vector buffer 108 stores motion vectors of previously encoded MBs as reference motion vectors for use in generating subsequent motion vector differences. The reference offset parameter buffer 122 stores prediction offsets of previously encoded MBs as reference offsets for use in determining subsequent offset differences.

An intra/inter prediction unit, e.g. the motion compensation unit 102, performs motion compensation to generate a predictor of a current MB from data stored in the frame buffer 104 referring to a motion vector. A motion vector difference calculated from the motion vector and a motion vector predictor 106 derived from data stored in the reference motion vector buffer 108 is sent to the entropy coding unit 114 to be encoded in a bitstream. In this embodiment, WP will be performed, by a determination unit 130 coupled to the intra/inter prediction unit, on the predictor of each MB by adding a prediction offset derived by the offset estimation unit 116 to generate a modified predictor. Meanwhile, an offset difference which indicates the difference between the prediction offset applied to the current MB and an offset predictor 124 derived from one or more reference offsets will be calculated and sent to the entropy coding unit 114 to be encoded in the bitstream. A block transform process, performed by the transform unit 110, is applied to residuals to reduce spatial statistical correlation. The residuals are the sample-by-sample differences between the current MB and the modified predictor. For example, if the current MB size is 16×16, the residuals may be divided into four 8×8 blocks. To each 8×8 residual, the encoder 100 applies a reversible frequency transform operation, which generates a set of frequency domain (i.e., spectral) coefficients. A discrete cosine transform (DCT) is an example of frequency transform. The output of the transform unit 110 is then quantized (Q) by the quantization unit 112 to obtain quantized values.

Following quantization, the entropy coding unit 114 encodes the quantized values and inserts the weighted prediction parameter to generate a bitstream. For example, the entropy coding unit 114 may perform content adaptive variable length coding (CAVLC), context adaptive binary arithmetic coding (CABAC), or other entropy coding methodologies.

The encoder 100 further performs inverse quantization by the inverse quantization unit 118 and inverse transform by the inverse transform unit 120 to recover the residuals, and combines the residuals with the modified predictor to compute a reconstructed MB. The reconstructed MB is stored in the frame buffer 104 for use by subsequent MBs. Note that in this embodiment, the resulting bitstream includes entropy coded residuals, motion vector differences, and offset differences. In some other embodiments, the bitstream may include weighted prediction parameters other than offset differences, such as scaling factor differences, prediction offsets, scaling factors, or any of the combinations.

During decoding, a decoder typically decodes data and performs analogous operations to reconstruct MBs. The decoder decodes segments by generating a modified predictor for each segment from a predictor with weighted prediction, where the predictor is derived from motion compensation, and then the decoder combines the modified predictors with recovered residuals.

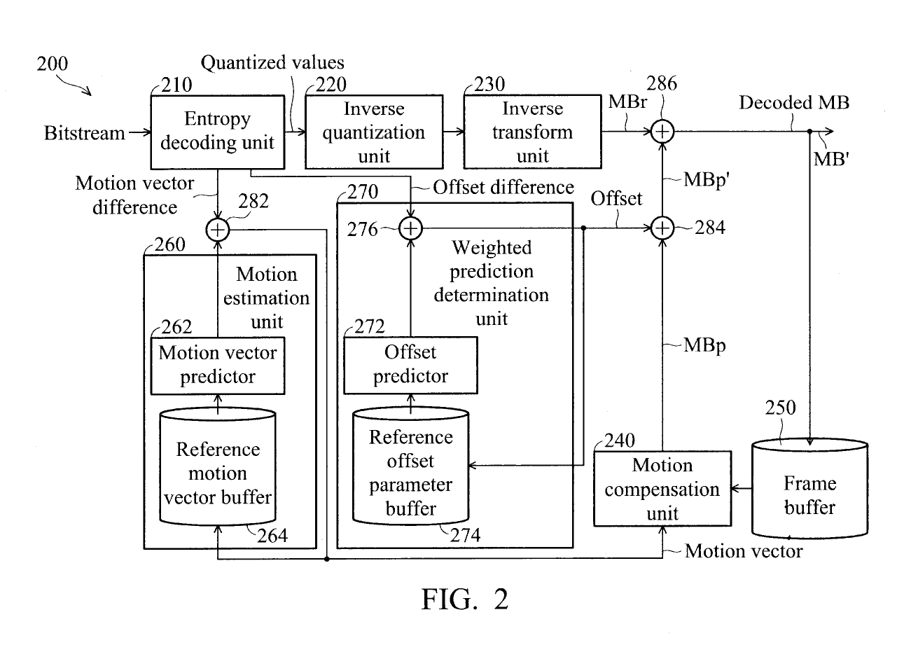

FIG. 2 is a block diagram showing an embodiment of a video decoder 200 decoding a bitstream with MB level weighted prediction. In this embodiment, weighted prediction parameters in the bitstream only include offset differences, in some other embodiments, weighted prediction parameters may include one or a combination of scaling factors, prediction offsets, scaling factor differences, and offset differences.

The video decoder 200 comprises an entropy decoding unit 210, an inverse quantization unit 220, an inverse transform unit (e.g. an inverse discrete cosine transform (IDCT) unit) 230, a motion compensation unit 240, a frame buffer 250, a motion estimation unit 260 and a weighted prediction determination unit 270. The motion estimation unit 260 further comprises a motion vector predictor 262 and a reference motion vector buffer 264. The weighted prediction determination unit 270 further comprises an offset predictor 272, a reference offset parameter buffer 274 and an adder 276. The reference motion vector buffer 264 stores motion vectors of previously decoded MBs as reference motion vectors for use in generating subsequent motion vectors. The reference offset parameter buffer 274 stores prediction offsets of previously decoded MBs as reference offset for use in determining subsequent prediction offset.

The entropy decoding unit 210 of the video decoder 200 decodes an input bitstream to generate decoded data. For example, in this embodiment, the decoded data may comprise motion vector differences, offset differences and quantized values representing residual data. The quantized values are sent to the inverse quantization unit 220 and the inverse transform unit 230 to recover residuals MBr, the offset differences are sent to the weighted prediction determination unit 270 to generate prediction offsets, and the motion vector differences are sent to the motion estimation unit 260 to generate motion vectors. The inverse quantization unit 220 performs an inverse quantization operation on the quantized values representing residual data to output de-quantized data (e.g. DCT coefficient data) to the inverse transform unit 230. Inverse transform (e.g. an IDCT operation) is then performed by the inverse transform unit 230 to generate residuals MBr. An adder 286 generates a decoded current MB by adding the residuals of the current MB MBr to the modified predictor MBp′ of the current MB. Decoded MB data MB′ is stored into a frame buffer 250 for decoding subsequent MBs. The motion compensation unit 240 receives the motion vectors and the previously decoded MB data, and performs motion compensation to provide an original predictor MBp to an adder 284. The adder 284 generates the modified predictor MBp′ by adding the original predictor MBp by the prediction offset calculated by the weighted prediction determination unit 270.

The weighted prediction determination unit 270 receives the offset differences from the entropy decoding unit 210 and generates a prediction offset for the current MB according to an offset difference of the current MB and an offset predictor of the current MB. The offset predictor 272 may first generate the offset predictor of the current MB with reference to the reference offset parameters stored in the reference offset parameter buffer 274. The reference offset parameters may be the prediction offsets of previously decoded MBs.

The offset predictor of the current MB may be predicted from one or more of previously decoded MBs (either in spatial or temporal domain). For example, the offset predictor of the current MB may be determined by prediction offsets of previously decoded neighboring MBs. In some embodiments, the offset predictor of the current MB is predicted based on at least a first prediction offset of a first decoded MB and a second prediction offset of a second decoded MB. In one embodiment, the first decoded MB and the second decoded MB are within a same slice or picture, and are referred to as spatial neighbors of the current MB.

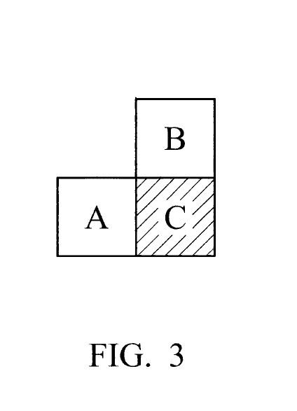

Refer to FIG. 3, which illustrates an embodiment of deriving an offset predictor. As shown in FIG. 3, MB A on the left side and MB B on the top are neighboring MBs of current MB C. The offset predictor of current MB C may be calculated by an exemplary formula shown in the following:

oₚ=(o_{A}+o_{B})/2 (1),

where oₚ represents the offset predictor of current MB C, o_{A} represents the prediction offset of MB A and o_{B} represents the prediction offset of MB B. In this embodiment, the offset predictor of the current MB is set to an average of the prediction offsets of two decoded neighboring MBs, but the invention is not limited thereto. In another embodiment, the offset predictor oₚ of the current MB can be predicted based on at least a first offset of a first decoded MB, where the first decoded MB and the current MB are in different slices or pictures. For example, the offset predictor of the current MB is predicted based on a first offset of a first decoded MB and a second offset of a second decoded MB, and the first decoded MB is a collocated MB located in a first reference picture and the second decoded MB is a collocated MB located in a second reference picture. In this case, the first decoded MB and the second decoded MB may be referred to as temporal neighbors of the current MB.

The calculated offset predictor (oₚ) of the current MB is added to the corresponding offset difference (o_{d}) and a prediction offset (o) of the current MB may be obtained by an exemplary formula shown in the following:

o=oₚ+o_{d}, (2),

The modified predictor MBp′ used to predict the current MB can be calculated by an exemplary formula shown in the following:

MBp′=o+MBp (3),

where MBp represents an original predictor that is obtained by means of interpolation in the case of a sub-pixel precision motion vector or directly from the previously decoded pictures.

In some embodiments, when the weighted prediction parameters include only scaling factors or scaling factor related information, the modified predictor MBp′ used to predict the current MB can be calculated by an exemplary formula shown in the following:

MBp′=S×MBp (4),

where S represents the scaling factor.

In some embodiments, when the weighted prediction parameters include both offset and the scaling factor related information, the modified predictor MBp′ used to predict the current MB can be calculated by an exemplary formula shown in the following:

MBp′=S×MBp+o (5).

The modified predictor MBp′ of a current MB is added to corresponding residuals MBr and the current MB MB′ may then be reconstructed by an exemplary formula shown in the following:

MB′=MBP′+MBr (6).

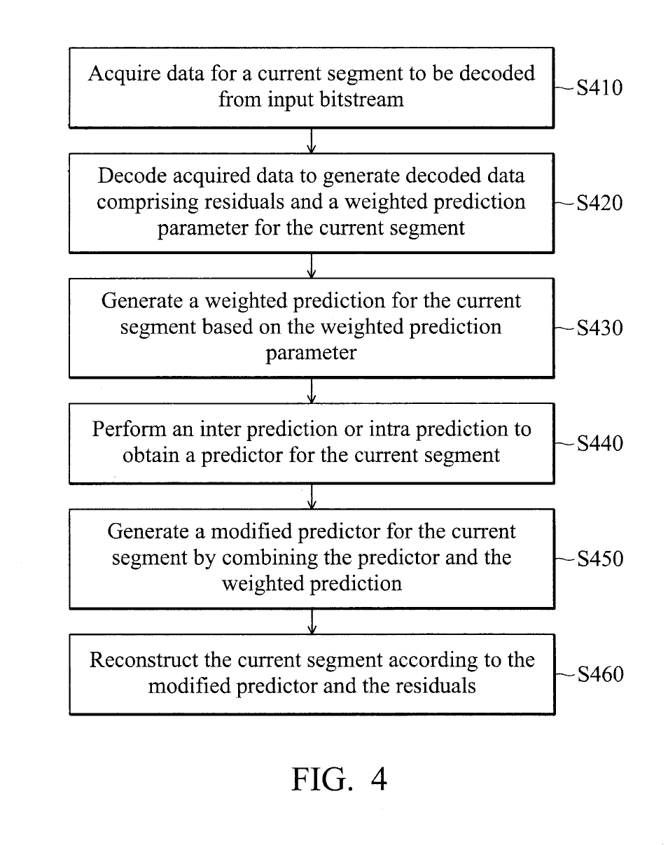

FIG. 4 is a flowchart of an embodiment of a video decoding method of the invention. The video decoding method of the invention may be applied on the video decoder 200 as shown in FIG. 2. Referring to FIGS. 2 and 4, in step S410, data for a current segment (e.g. one MB in FIG. 2) to be decoded is acquired from an input bitstream. Note that, in this embodiment, the bitstream comprises one or more frames or slices and each frame or slice is divided into a plurality of segments. Data for a segment may comprise encoded residual data and multiple different data (e.g. motion vector differences, reference picture index, and etc.) which are encoded by CABAC in the encoder (e.g. the encoder 100 of FIG. 1). In step S420, the acquired data for the current segment is decoded, by a decoding unit (e.g. the entropy decoding unit 210), to generate decoded data at least comprising residuals and a weighted prediction parameter for the current segment. In step S430, a weighted prediction (e.g. a prediction offset, a scaling factor, or both) for the current segment is generated (e.g. by the weighted prediction determination unit 270) based on the weighted prediction parameter. The weighted prediction of the current segment may be generated by combining the weighted prediction parameter with data (e.g. offset predictor) predicted from at least one of previously decoded data (e.g. a prediction offset of previously decoded segment). Note that the previously decoded segment may be a spatial or temporal neighbor, or temporal collocated segment of the current segment.

Inter prediction or intra prediction is performed in step S440, by a motion compensation unit (e.g. the motion compensation unit 240) or intra prediction unit, to obtain a predictor for the current segment (e.g. MBp). In step S450, a modified predictor (e.g. MBp′) for the current segment is generated by combining the predictor (e.g. MBp) and the weighted prediction (e.g. prediction offset). Last, in step S460, the current segment is reconstructed based on the modified predictor (e.g. MBp′) and corresponding residuals (e.g. MBr).

In some embodiments, flags are inserted in the bitstream to indicate whether weighted prediction is enabled for each segment (e.g. each MB). In some other embodiments, flags are inserted in a slice header of the bitstream to indicate whether weighted prediction is used. These flags indicating the existence of weighted prediction parameters provide flexibility of adaptive use of localized weighted prediction. For example, if the flag is set to “0”, the video decoder is notified that weighted prediction is enabled, if the flag is set to “1”, the video decoder is notified that weighted prediction is disabled. In some other embodiments, there is a flag inserted in the bitstream to indicate the slice(s) is encoded by slice level weighted prediction or localized weighted prediction. Another flag may be used to indicate the size of segments for localized weighted prediction. For example, the video decoder may determine whether a flag indicating the use localized weighted prediction is present in a bitstream (e.g. from a GOP header, or a slice header) and if so, acquires weighted prediction parameters to decode the slice(s). The weighted prediction parameters could be different for each segment if the flag has been set.

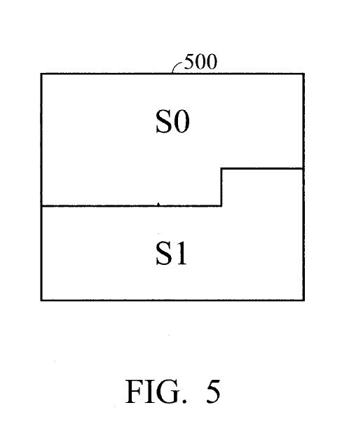

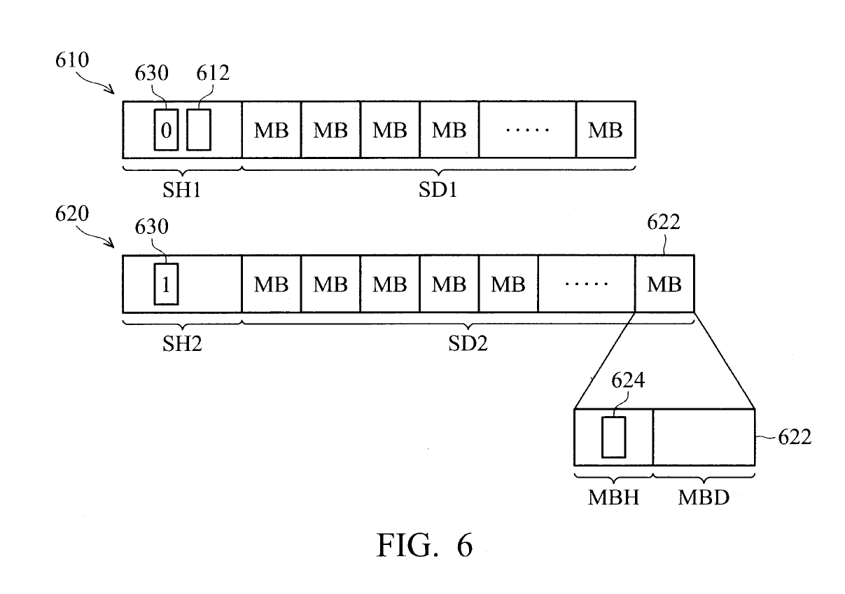

FIG. 5 illustrates an embodiment of a video frame. As shown in FIG. 5, a video frame 500 is divided into two slices S0 and S1, wherein each of slices S0 and S1 may be further divided into multiple segments. FIG. 6 illustrates an embodiment of a frame structure of FIG. 5, wherein 610 and 620 respectively represent slice content of slices S0 and S1. As shown in FIG. 6, the slice format has a header region SH and a slice data region SD containing segment data within the slice. In the case when flag 630 indicating localized weighted prediction is disabled and slice level weighted predication is applied, the header region SH comprises a set of weighted prediction parameters 612 for the entire slice 610. In the case when flag 630 indicating localized weighted prediction is enabled, the weighted prediction parameters, for example, 624, will be found from the header MBH of each MB in slice 620, for example, MB 622. As shown in slice 610 of FIG. 6, flag 630 is set to “0”, the video decoder 200 will obtain a weighted prediction parameter from the header SH1 and use the obtained weighted prediction parameter to apply slice-level weighted prediction for every MBs in slice 610. As shown in slice 620 of FIG. 6, flag 630 is set to “1”, the video decoder 200 will obtain weighted prediction parameters from the header MBH of each MB and uses the obtained weighted prediction parameters to apply MB-level weighted prediction.

Note that, in some embodiments, weighted prediction parameters may be quantized at the encoder with a quantization accuracy related to the residual data, for example, the bigger Quantization Parameter (QP) of the MB residual data is, the lower the quantization accuracy of weighted prediction parameter is. In this case, the video decoder 200 should further de-quantize the decoded weighted prediction parameter with an appropriate quantization accuracy before applying the weighted prediction parameter in the decoding process.

In summary, according to the video encoder and decoder and the video en coding and decoding methods of the invention, one or more weighted predicted parameters are provided for each segment so as to adapt the local illumination intensity variation between segments.

Video decoders, video encoders, video coding and decoding methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention (e.g., use a ring buffer). Therefore, the scope of the present invention shall be defined and protected by the following claims and their equivalents.

1. A method for video decoding, comprising:
acquiring data for a current segment to be decoded from an input bitstream;
decoding the acquired data to generate decoded data comprising residuals and a weighted prediction parameter for the current segment;
generating a weighted prediction for the current segment based on the weighted prediction parameter;
generating a predictor for the current segment by intra/inter prediction;
combining the weighted prediction and the predictor to obtain a modified predictor; and
reconstructing the current segment according to the modified predictor and the residuals;
wherein the weighted prediction for the current segment is predicted from a weighted prediction of a previously decoded segment.

2. The method of claim 1, wherein the current segment is a block with a size smaller than a slice and a picture.

3. The method of claim 1, wherein the weighted prediction parameter comprises one or a combination of a prediction offset, a scaling factor, an offset difference, and a scaling difference.

4. The method of claim 1, wherein the weighted prediction for the current segment is predicted from weighted predictions of previously decoded segments.

5. The method of claim 4, further comprising:
generating the weighted prediction for the current segment by predicting based on a first weighted prediction of a first decoded segment and a second weighted prediction of a second decoded segment, and combing with the weighted prediction parameter, wherein the first decoded segment and the second decoded segment are located within the same slice as the current segment.

6. The method of claim 1 further comprising:
generating the weighted prediction for the current segment by predicting based on a first weighted prediction of a first decoded segment, and combining with the weighted prediction parameter, wherein the first decoded segment and the current segment are located in different slices.

7. The method of claim 1, wherein the weighted prediction parameter is decoded from the acquired data with context adaptive binary arithmetic coding (CABAC) or content adaptive variable length coding (CAVLC).

8. The method of claim 1, wherein the weighted prediction parameter is de-quantized using a quantization accuracy related to a quantization parameter for de-quantizing the residuals.

9. The method of claim 1, further comprising:
acquiring a flag from the input bitstream indicates whether to apply localized weighted prediction; and
acquiring one or more weighted prediction parameters for segments of a slice according to the flag.

10. A video decoder, comprising:
a decoding unit, acquiring data for a current segment to be decoded from an input bitstream and decoding the acquired data to generate decoded data comprising residuals and a weighted prediction parameter for the current segment;
a determination unit coupled to the decoding unit, generating a weighted prediction for the current segment based on the weighted prediction parameter, and the weighted prediction is predicted from a weighted prediction of a previously decoded segment;
a motion compensation unit generating a predictor for the current segment by intra/inter prediction; and
a first adder coupled to the determination unit and motion compensation unit, combining the weighted prediction and the predictor to obtain a modified predictor;
wherein the video decoder reconstructs the current segment according to the modified predictor and the residuals.

11. The video decoder of claim 10, wherein the weighted prediction parameter comprises one or a combination of a prediction offset, a scaling factor, an offset difference, and a scaling difference.

12. The video decoder of claim 10, wherein the determination unit generates the weighted prediction for the current segment by predicting from weighted predictions of previously decoded segments.

13. The video decoder of claim 12, wherein the determination unit generates the weighted prediction for the current segment by predicting based on a first weighted prediction of a first decoded segment and a second weighted prediction of a second decoded segment, and combines with the weighted prediction parameter, wherein the first decoded segment and the second decoded segment are located within the same slice as the current segment.

14. The video decoder of claim 10 wherein the determination unit generates the weighted prediction for the current segment by predicting based on a first weighted prediction of a first decoded segment, and combines with the weighted prediction parameter, wherein the first decoded segment and the current segment are located in different slices.

15. The video decoder of claim 10, further comprising an inverse quantization unit, de-quantized the weighted prediction parameter using a quantization accuracy related to a quantization parameter for de-quantizing the residuals.

16. The video decoder of claim 10, wherein the decoding unit acquires a flag from the input bitstream, and determines whether to apply localized weighted prediction according to the flag.

17. A method for video encoding, comprising:
acquiring a current segment of a slice to be encoded;
generating a predictor of the current segment by intra/inter prediction;
performing weighted prediction on the predictor of the current segment to generate a modified predictor and a weighted prediction parameter;
generating residuals according to the current segment and the modified predictor; and
encoding the residuals and inserting the weighted prediction parameter to generate a bitstream;
wherein performing weighted prediction further comprises predicting a weighted prediction of the current segment from a weighted prediction of a previously reconstructed segment.

18. The method of claim 17, wherein the weighted prediction parameter comprises one or a combination of a prediction offset, a scaling factor, an offset difference, and a scaling difference.

19. The method of claim 17, wherein performing weighted prediction further comprises predicting a weighted prediction of the current segment from weighted predictions of previously reconstructed segments.

20. The method of claim 17, further comprising determining whether to apply localized weighted prediction and inserting a flag in the bitstream for indication.

21. A video encoder, comprising:
an intra/inter prediction unit, generating a predictor of a current segment by intra/inter prediction;
a determination unit, coupled to the intra/inter prediction unit, performing weighted prediction on the predictor of the current segment to generate a modified predictor and a weighted prediction parameter, and predicts a weighted prediction of the current segment from a weighted prediction of a previously reconstructed segment;
a transform and quantization unit, receiving residuals and performing transform and quantization on the residuals to generate quantized values, wherein the residuals are generated according to the current segment and the modified predictor; and
an entropy coding unit, encoding the quantized values and inserting the weighted prediction parameter to generate a bitstream.

22. The video encoder of claim 21, wherein the weighted prediction parameter comprises one or a combination of a prediction offset, a scaling factor, an offset difference, and a scaling difference.

23. The video encoder of claim 21, wherein the determination unit predicts a weighted prediction of the current segment from weighted predictions of previously reconstructed segments.

24. The video encoder of claim 21, wherein the entropy coding unit further inserts a flag to indicate whether to apply localized weighted prediction.
